(19) United States
(12) Patent Application Publication
(10) Pub. No.: US 2013/0201719 A1
(43) Pub. Date: Aug. 8, 2013

(54) FRONT LIGHT MODULE

(71) Applicant: Heng-Sheng Kuo, New Taipei City (TW)

(72) Inventor: Heng-Sheng Kuo, New Taipei City (TW)

(21) Appl. No.: 13/365,248

(22) Filed: Feb. 2, 2012

(51) Int. Cl. F21V 7/04

(52) U.S. Cl. 362/603

(57) ABSTRACT

A front light module includes a light source and a light-guiding plate. The light-guiding plate is disposed outside a panel. The light-guiding plate receives the light emitted by the light source and reflects the light onto the panel. The light-guiding plate includes a first reflecting surface facing the panel and a second reflecting surface opposite to the first reflecting surface. An included angle is formed between the panel and the first reflecting surface or the second reflecting surface. The front light module can reflect the light onto the panel uniformly to generate sufficient brightness.

### BACKGROUND OF THE INVENTION

1. Field of the Invention

The present invention relates to a light module, and in particular to a front light module.

2. Description of Prior Art

In general, a display panel is additionally provided with a light module for generating a light source of sufficient brightness and uniform distribution. By this structure, the display panel can display images with uniform and high brightness as well as a wide viewing angle.

Based on the position of the light module, a front light module is a light module mounted in front of glass chips and color filters. The front light module is capable of converting a point or linear light source into a planar light source via a light-guiding structure, thereby generating a planar surface having high brightness and uniform luminance. In the daytime and in a place with sufficient illumination, the front light module can generate sufficient brightness by using an external light source. When the external light source is insufficient in brightness, the front light module can activate the light source to make the display panel to display images normally. Thus, the display panel having a front light module can reduce its electricity consumption, so that it is suitable for personal digital assistants (PDA), smart phones, electric books or other portable information devices.

Traditionally, the light-guiding structure in the front light module is formed with a plurality of microstructures on a display surface of a light-guiding plate. The microstructures may be configured as troughs, V-shaped troughs or toothed troughs for distributing a point or linear light source into a planar light source with uniform luminance. However, the size of each microstructure is so small that they cannot be processed on the light-guiding plate easily. Further, since the microstructures are only provided on a front end surface of the light-guiding plate, the light-guiding plate can scatter the light entering the microstructures only because the light in parallel to the bottom surface of the light-guiding plate will be absorbed or emitted via other surface. As a result, the light-guiding efficiency of the light-guiding plate is reduced.

In view of the above, the present Inventor proposes a novel and reasonable structure based on his expert knowledge and deliberate researches.

### SUMMARY OF THE INVENTION

The present invention is to provide a front light module, which is capable of reflecting light onto a panel uniformly to thereby provide sufficient brightness.

The present invention provides a front light module for providing light to a panel. The front light module includes a light source and a light-guiding plate. The light source is formed with a light-exiting surface. The light-guiding plate is disposed outside a display surface of the panel. The light-guiding plate receives the light emitted from the light-exiting surface and reflects the light onto the panel. The light-guiding plate comprises a first reflecting surface facing the panel and a second reflecting surface opposite to the first reflecting surface, wherein an included angle is formed between the panel and the first reflecting surface or the second reflecting surface.

In comparison with prior art, the light-guiding plate of the front light module of the present invention comprises the first reflecting surface facing the panel and the second reflecting surface opposite to the first reflecting surface. Further, an included angle is formed between the panel and the first reflecting surface or the second reflecting surface. The present invention can replace the conventional light-guiding plate in which the microstructures are formed on an outer end surface (equivalent to the second reflecting surface of the present invention) of the light-guiding plate to reflect the light. Thus, the present invention can shorten the manufacturing process of the light-guiding plate. Further, the first reflecting surface or the second reflecting surface of the present invention is an inclined surface for reflecting most of the light emitted by the light source onto the panel uniformly. Thus, the present invention increases the light-guiding efficiency of the light-guiding plate and provides sufficient brightness. Therefore, the practicability of the present invention is increased.

### BRIEF DESCRIPTION OF DRAWING

FIG. 1 is a perspective view showing the external appearance of the front light module according to the present invention;

FIG. 2 is a top view showing the front light module of the present invention;

FIG. 3 is a schematic view showing that the front light module of the present invention reflects the light emitted by a light source;

FIG. 4 is a schematic view showing the front light module according to a second embodiment of the present invention;

FIG. 5 is a schematic view showing the front light module according to a third embodiment of the present invention;

FIG. 6 is a schematic view showing the front light module according to a fourth embodiment of the present invention;

FIG. 7 is a schematic view showing the front light module according to a fifth embodiment of the present invention;

FIG. 8 is a schematic view showing the front light module according to a sixth embodiment of the present invention;

FIG. 9 is a schematic view showing the front light module according to a seventh embodiment of the present invention;

FIG. 10a is a top view showing the light-guiding plate of the present invention;

FIG. 10b is a front view showing the light-guiding plate of the present invention; and

FIG. 11 is a schematic view showing the application of the light-guiding plate of the present invention.

### DETAILED DESCRIPTION OF THE INVENTION

The detailed description and technical contents of the present invention will become apparent with the following detailed description accompanied with related drawings. It is noteworthy to point out that the drawings is provided for the illustration purpose only, but not intended for limiting the scope of the present invention.

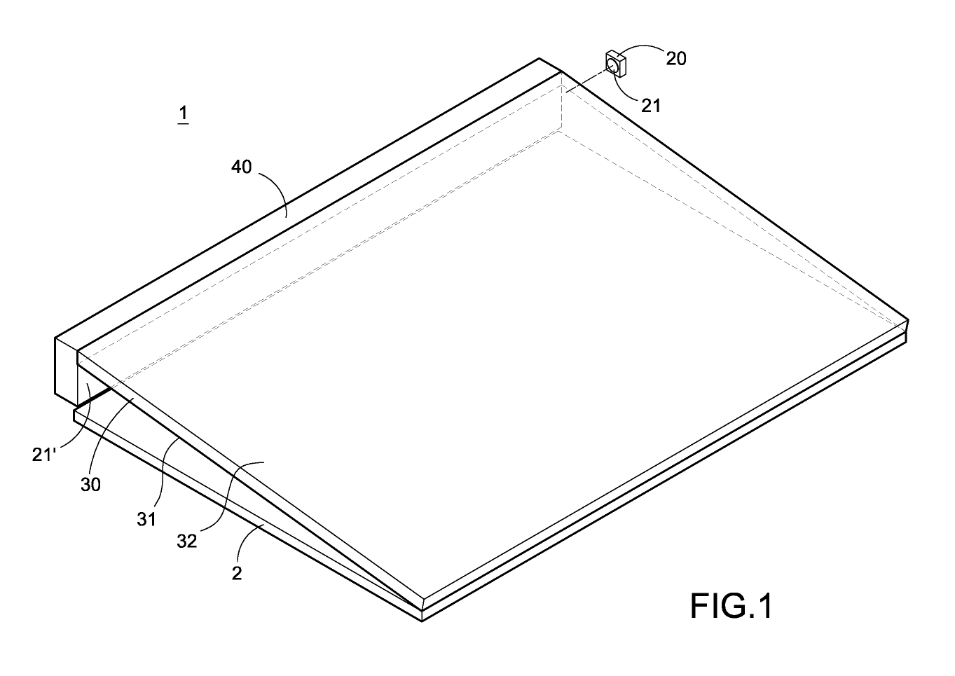

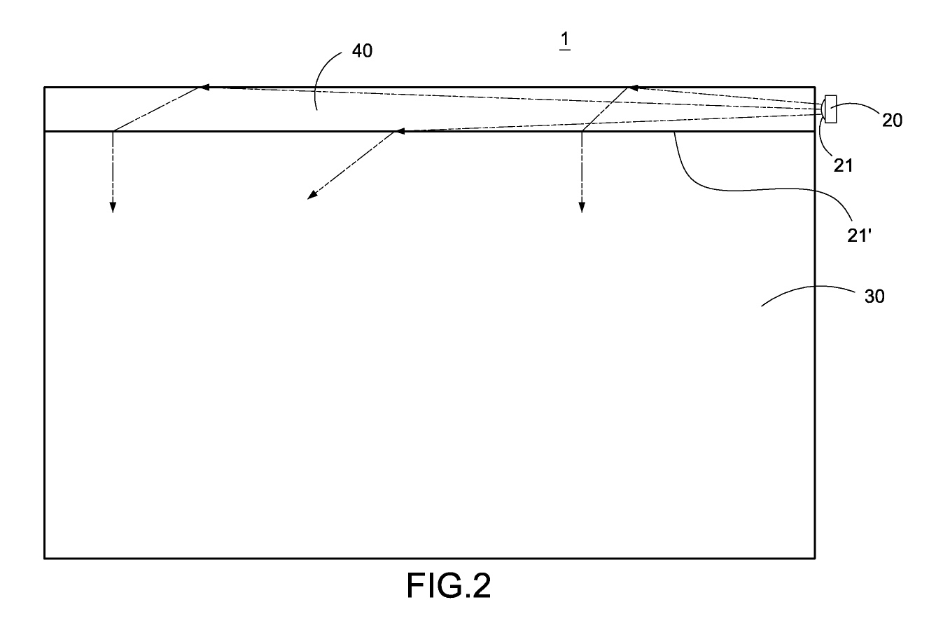

Please refer to FIGS. 1 and 2. FIG. 1 is a perspective view showing the external appearance of the front light module according to the present invention, and FIG. 2 is a top view showing the front light module of the present invention. The front light module 1 of the present invention is used to provide light to a panel 2. The front light module 1 includes a light source 20, a light-guiding plate 30, and a second light-guiding plate 40.

The light source 20 is an optical diode such as a light emitting diode (LED) or a laser diode (LD), but it is not limited thereto. The light source 20 may be a cold cathode fluorescent lamp (CCFL) or other light sources. The light source 20 is formed with a light-exiting surface 21.

The light-guiding plate 30 and the second light-guiding plate 40 are made of materials having high reflectivity without absorbing the light. The light-guiding plate 30 is disposed outside the display surface of the panel 2. The light-guiding plate 30 is used to receive the light emitted from the light-exiting surface 21 and reflect the light onto the panel 2. In the present invention, the second light-guiding plate 40 is disposed on one side of the light-guiding plate 30. The second light-guiding plate 40 receives the light emitted by the light source 20 (a point light source) and reflects the light to another light-exiting surface 21′ (planar light source), thereby providing an uniform light source.

Further, the light-guiding plate 30 comprises a first reflecting surface 31 facing the panel 2 and a second reflecting surface 32 opposite to the first reflecting surface 31. An included angle is formed between the panel 2 and the first reflecting surface 31 or the second reflecting surface 32. In the present embodiment, the light-guiding plate 30 is a rectangular body. The light-guiding plate 30 is obliquely disposed on one side of the second light-guiding plate 40. The light-guiding plate 30 is obliquely disposed from the light-exiting surface 21′ toward the panel 2.

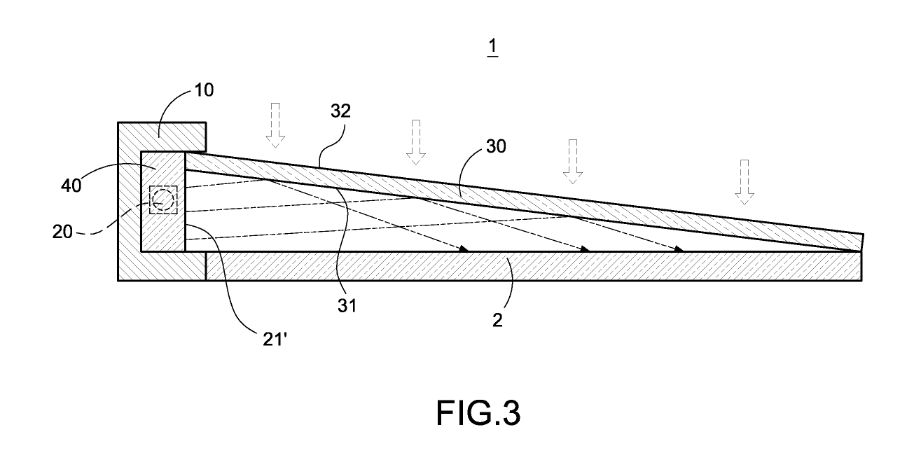

Please refer to FIG. 3, which is a schematic view showing that the front light module of the present invention reflects the light emitted by the light source. In the present embodiment, the front light module 1 is provided with a frame 10. The light source 20, the light-guiding plate 30, and the second light-guiding plate 40 are fixed to the frame 10. As shown in FIG. 3, the light source 20 is fixed to one side of the frame 10. The light emitted from the light source 20 is reflected to the light-guiding plate 30 by the second light-guiding plate 40. That is to say, the second light-guiding plate 40 receives the light emitted by the light source 20 and reflects the light onto the light-exiting surface 21′. The light emitted from the light-exiting surface 21′ illuminates the light-guiding plate 30 and then passes through the light-guiding plate 30 to be reflected onto the panel 2. Since the light-guiding plate 30 is obliquely disposed from the light-exiting surface 21′ toward the panel 2, the first reflecting surface 31 is an inclined surface for reflecting most of the light onto the panel 2 uniformly to provide uniform brightness.

When the external environment has sufficient illumination, the external light passes through the light-guiding plate 30 to illuminate the panel 2. As a result, even the light source 20 is not activated, the present invention can still provide sufficient brightness to the panel 2.

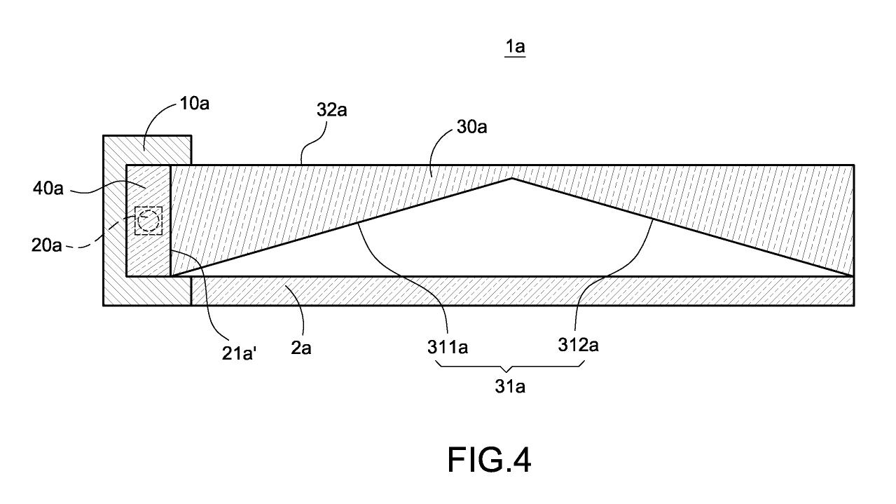

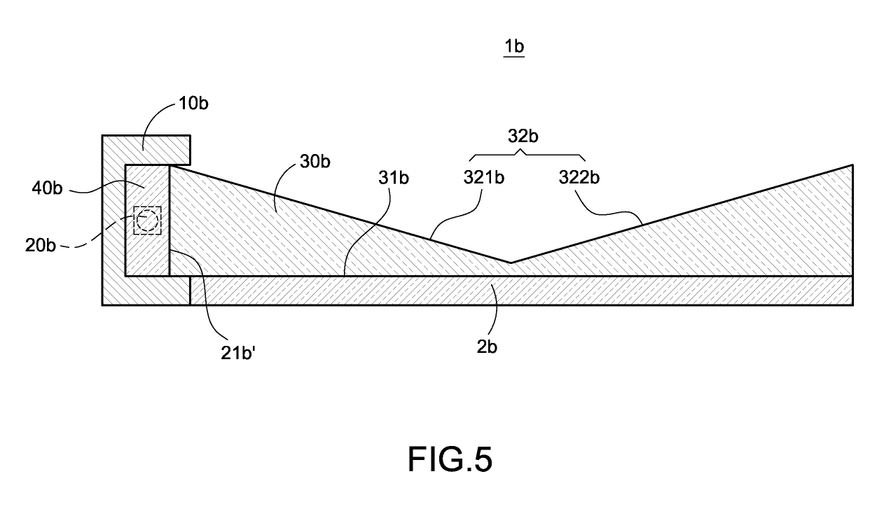

Please refer to FIGS. 4 and 5, which show the front light module according to the second embodiment and the third embodiment of the present invention respectively. In the second embodiment, the front light module 1a includes a frame 10a, a light source 20a, a light-guiding plate 30a, and a second light-guiding plate 40a. The second light-guiding plate 40a receives the light emitted by the light source 20a and reflects the light to form a light-exiting surface 21a′. The difference between the present embodiment and the first embodiment lies in the arrangement of the light-guiding plate 30a.

In FIG. 4, the light-guiding plate 30a comprises a first reflecting surface 31a facing the panel 2a and a second reflecting surface 32a opposite to the first reflecting surface 31a. An included angle is formed between the panel 2a and the first reflecting surface 31a. The second reflecting surface 32a is oriented to be parallel to the panel 2a. The first reflecting surface 31a comprises a positive inclined surface 311a adjacent to the light-exiting surface 21a′ and a negative inclined surface 312a connected to the positive inclined surface 311a. The positive inclined surface 311a has a positive inclination relative to the panel 2a. The negative inclined surface 312a has a negative inclination relative to the panel 2a. The positive inclined surface 311a and the negative inclined surface 312a are provided to reflect the light emitted by the light-exiting surface 21a′.

In FIG. 5, the front light module 1b includes a frame 10b, a light source 20b, a light-guiding plate 30b, and a second light-guiding plate 40b. The second light-guiding plate 40b receives the light emitted by the light source 20b and reflects the light to form a light-exiting surface 21b′. The light-guiding plate 30b comprises a first reflecting surface 31b facing the panel 2b and a second reflecting surface 32b opposite to the first reflecting surface 31b. The first reflecting surface 31b is oriented to be parallel to the panel 2b. An included angle is formed between the panel 2b and the second reflecting surface 32b. The second reflecting surface 32b comprises a negative inclined surface 321b adjacent to the light-exiting surface 21b′ and a positive inclined surface 322b connected to the negative inclined surface 321b. The negative inclined surface 321b has a negative inclination relative to the panel 2b. The positive inclined surface 322b has a positive inclination relative to the panel 2b.

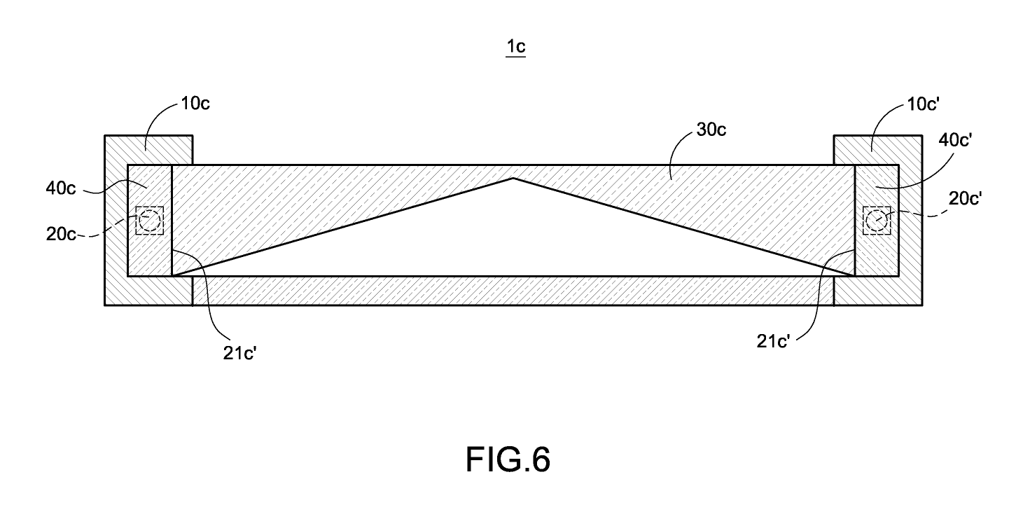

Please refer to FIG. 6, which shows the front light module according to the fourth embodiment of the present invention. The fourth embodiment is substantially the same as the second embodiment except for the fact that the front light module 1c comprises two separate frames 10c, 10c′, two light sources 20c, 20c′, and two second light-guiding plates 40c, 40c′. The two second light-guiding plates 40c, 40c′ receive the light emitted by the two light sources 20c, 20c′ respectively and reflect the light to form a light-exiting surface 21c′. The two frames 10c, 10c′ and the two light sources 20c, 20c′ are disposed to two opposite sides of the light-guiding plate 30c.

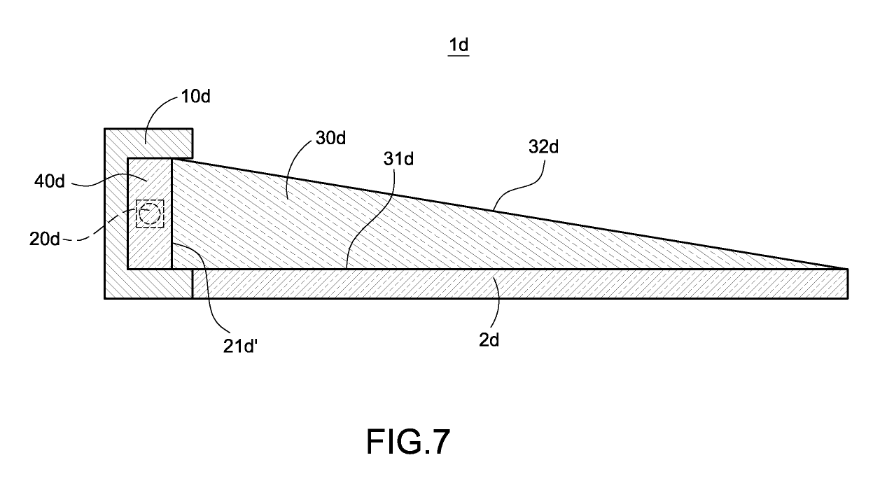

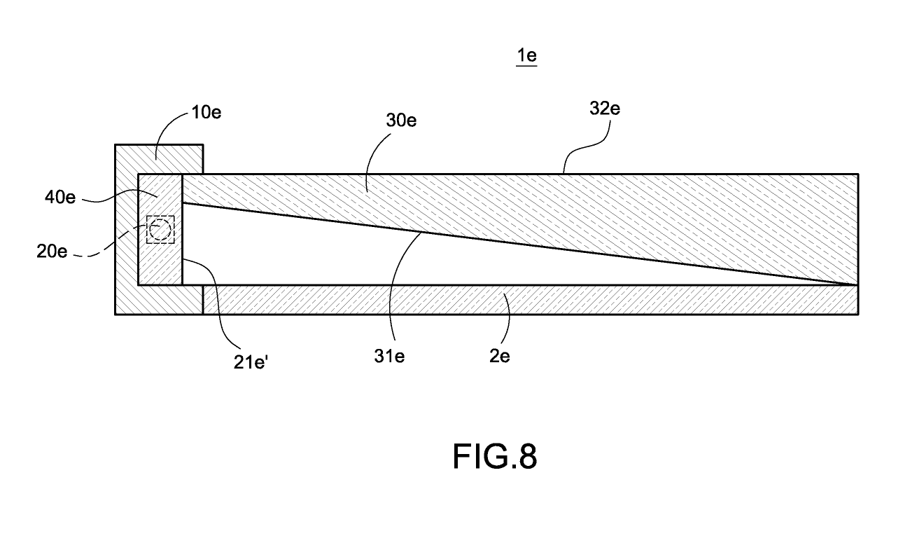

Please refer to FIGS. 7 and 8, which show the front light module according to the fifth embodiment and the sixth embodiment of the present invention respectively. In the fifth embodiment, the front light module 1d includes a frame 10d, a light source 20d, a light-guiding plate 30d, and a second light-guiding plate 40d. The second light-guiding plate 40d receives the light emitted by the light source 20d and reflects the light to form a light-exiting surface 21d′. The difference between the fifth embodiment and the first embodiment lies in the arrangement of the light-guiding plate 30d.

In FIG. 7, the light-guiding plate 30d has a triangular cross section. The light-guiding plate 30d comprises a first reflecting surface 31d facing the panel 2d and a second reflecting surface 32d opposite to the first reflecting surface 31d. The first reflecting surface 31d is oriented to be parallel to the panel 2d. An included angle is formed between the panel 2d and the second reflecting surface 32d.

In FIG. 8, the front light module 1e includes a frame 10e, a light source 20e, a light-guiding plate 30e, and a second light-guiding plate 40e. The second light-guiding plate 40e receives the light emitted by the light source 20e and reflects the light to form a light-exiting surface 21e′. The difference between the sixth embodiment and the first embodiment lies in that the light-guiding plate 30e has a trapezoid cross section.

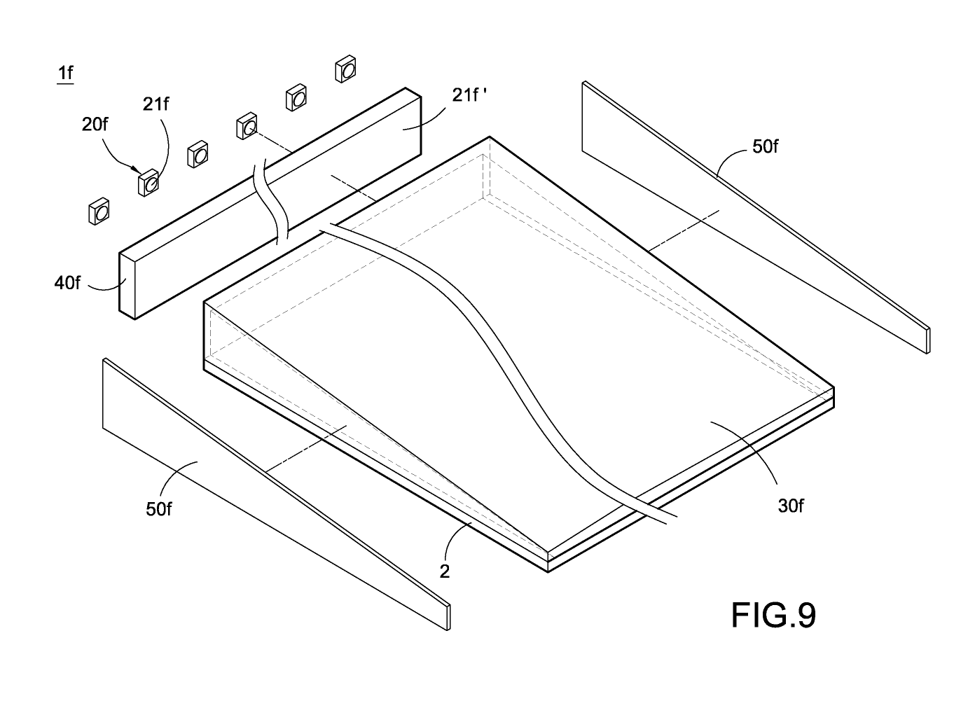

Please refer to FIG. 9, which shows the front light module according to the seventh embodiment of the present invention. In the present embodiment, the front light module 1f includes a light source 20f and a light-guiding plate 30f. The difference between the seventh embodiment and the first embodiment lies in that the light source 20f comprises a plurality of optical diodes. Each of the optical diodes has a light-exiting surface 21f. The front light module 1f further comprises a second light-guiding plate 40f and at least one reflecting piece 50f. The second light-guiding plate 40f receives the light emitted by the light source 20f and reflects the light to form a light-exiting surface 21f. The reflecting piece 50f is fixed to one side of the light-guiding plate 30f for converging the light emitted by the light source 20f, thereby increasing the brightness of the front light module 1f.

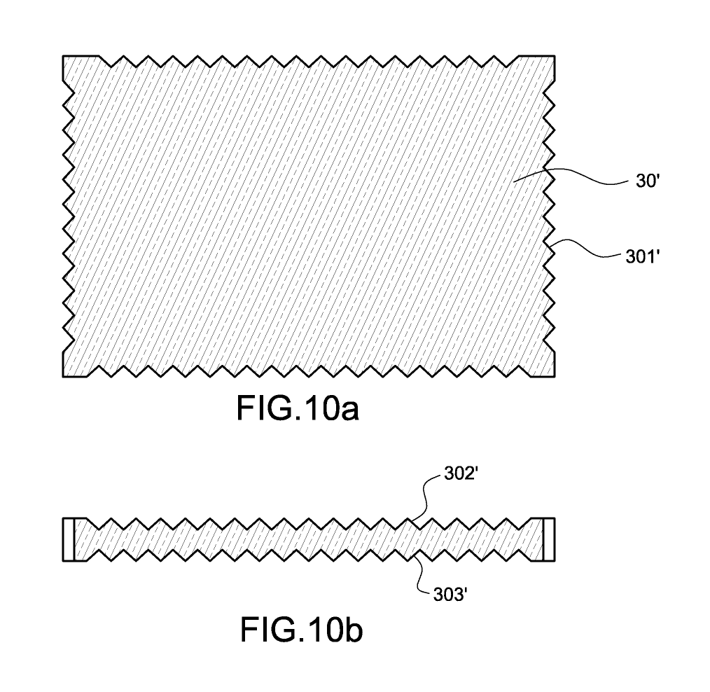

Please refer to FIGS. 10a and 10b, which are the top view and the front view showing the light-guiding plate of the present invention respectively. The periphery 301′ of the light-guiding plate 30′ is made toothed to increase the reflectivity and the reflecting effect of the light-guiding plate 30′. It should be noted that an upper surface 302′ or a lower surface 303′ of the light-guiding plate 30′ may be configured as a toothed surface to increase the reflecting effect.

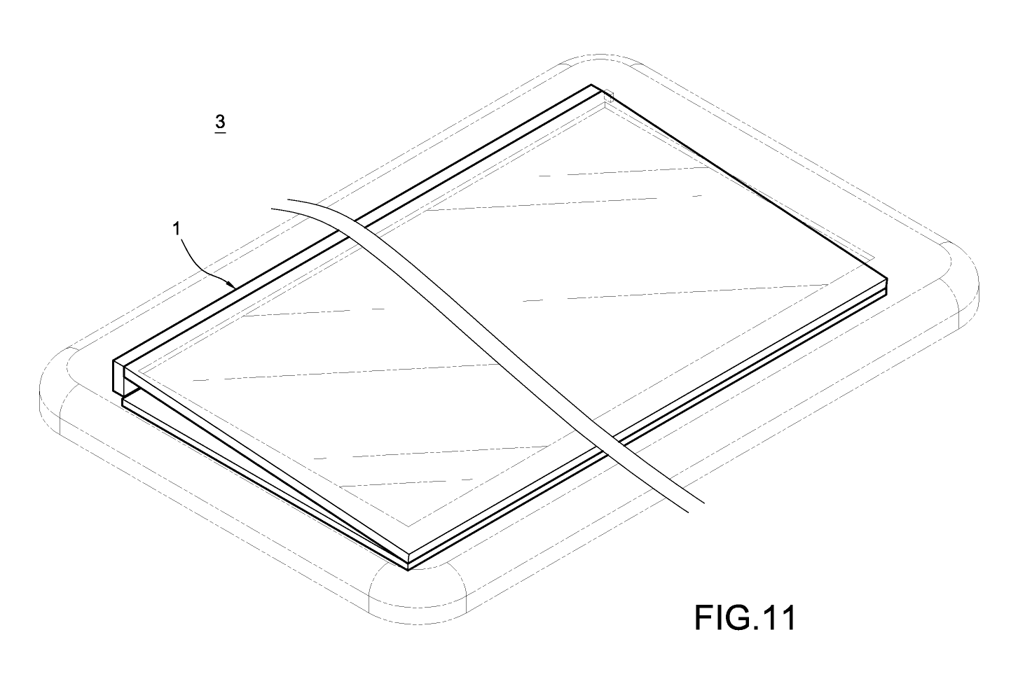

Please refer to FIG. 11, which is a schematic view showing the application of the front light module of the present invention. The front light module 1 of the present invention can be combined in a portable information device 3 to act as a light module of the portable information device 3.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A front light module, configured to provide light to a panel and including:
a light source formed with a light-exiting surface; and
a light-guiding plate disposed outside a display surface of the panel, the light-guiding plate receiving light emitted from the light-exiting surface and reflecting the light onto the panel, the light-guiding plate comprising a first reflecting surface facing the panel and a second reflecting surface opposite to the first reflecting surface,
wherein an included angle is formed between the panel and the first reflecting surface or the second reflecting surface.

2. The front light module according to claim 1, further including a frame, wherein the light source and the light-guiding plate are combined in the frame.

3. The front light module according to claim 2, further including another frame, the two frames being disposed on two opposite sides of the light-guiding plate.

4. The front light module according to claim 3, further including another light source, the two light sources are separated from each other and disposed on two opposites sides of the light-guiding plate.

5. The front light module according to claim 1, further including a second light-guiding plate disposed on one side of the light-guiding plate, the second light-guiding plate receiving the light emitted by the light source and reflecting the light to form the light-emitting surface.

6. The front light module according to claim 1, further including a reflecting piece fixed to one side of the light-guiding plate.

7. The front light module according to claim 1, wherein the light source is an optical diode.

8. The front light module according to claim 5, wherein the light-guiding plate is a rectangular body, the light-guiding plate is obliquely disposed on one side of the second light-guiding plate.

9. The front light module according to claim 1, wherein the light-guiding plate is obliquely disposed from the light-exiting surface toward the panel.

10. The front light module according to claim 1, wherein an included angle is formed between the panel and the first reflecting surface, the first reflecting surface comprises a positive inclined surface adjacent to the light source and a negative inclined surface connected to the positive inclined surface, the positive inclined surface has a positive inclination relative to the panel, the negative inclined surface has a negative inclination relative to the panel.

11. The front light module according to claim 10, wherein the second reflecting surface is parallel to the panel.

12. The front light module according to claim 1, wherein an included angle is formed between the panel and the second reflecting surface, the second reflecting surface comprises a negative inclined surface adjacent to the light source and a positive inclined surface connected to the negative inclined surface, the negative inclined surface has a negative inclination relative to the panel, the positive inclined surface has a positive inclination relative to the panel.

13. The front light module according to claim 12, wherein the first reflecting surface is parallel to the panel.

14. The front light module according to claim 1, wherein the light-guiding plate has a triangular cross section, the first reflecting surface is parallel to the panel, an included angle is formed between the panel and the second reflecting surface.

15. The front light module according to claim 1, wherein the light-guiding plate has a trapezoid cross section, the first reflecting surface is parallel to the panel, an included angle is formed between the panel and the second reflecting surface.

16. The front light module according to claim 1, wherein the periphery of the light-guiding plate is made toothed.

17. The front light module according to claim 1, wherein an upper surface or lower surface of the light-guiding plate is configured as a toothed surface.
